(19) United States
(12) Patent Application Publication
(10) Pub. No.: US 2024/0158602 A1
(43) Pub. Date: May 16, 2024

(54) METHOD OF RECYCLING C-14 IN SPENT RESIN AND APPARATUS FOR RECYCLING THE SAME

(71) Applicant: KOREA ATOMIC ENERGY RESEARCH INSTITUTE, Daejeon (KR)

(72) Inventors: Ki Rak LEE, Daejeon (KR); Hwan Seo PARK, Daejeon (KR); Geun Il PARK, Daejeon (KR); Ga Yeong KIM, Daejeon (KR); Jung Hoon CHOI, Daejeon (KR); Hyun Woo KANG, Daejeon (KR)

(73) Assignee: KOREA ATOMIC ENERGY RESEARCH INSTITUTE, Daejeon (KR)

(21) Appl. No.: 18/498,784

(22) Filed: Oct. 31, 2023

(30) Foreign Application Priority Data
Nov. 1, 2022 (KR) 10-2022-0143867

(51) Int. Cl. C08J 11/14

(52) U.S. Cl. CPC C08J 11/14; C08J 2325/06

(57) ABSTRACT

The present invention relates to a method of recycling C-14 in a spent resin, the method includes: i) heating a spent resin raw material including ¹⁴CO₂ in the presence of moisture by microwave irradiation; ii) refluxing, by condensation, water vapor in a first processing gas produced by the microwave irradiation and released from the spent resin raw material; and iii) removing water vapor from the first processing gas by the refluxing, and transporting a second processing gas including ¹⁴CO₂, which is released from the spent resin raw material, to the outside, and to an apparatus for recycling the same.

### CROSS REFERENCE TO RELATED APPLICATION

The present application claims priority to Korean Patent Application No. 10-2022-0143867, filed on Nov. 1, 2022, the entire contents of which is incorporated herein for all purposes by this reference.

### BACKGROUND OF THE INVENTION

### Field of the Invention

The present invention relates to a method of desorbing ¹⁴C (hereinafter, also referred to as “C-14” or “C-14 nuclide”) by inputting a radioactive spent resin into a microwave irradiation unit, and separating and processing the C-14 in the spent resin by adsorbing the desorbed radionuclide with a C-14 adsorbent, and an apparatus for the same.

### Description of the Related Art

In nuclear power plants, ion exchange resins are used to capture nuclides generated in the system, and the main nuclides are H-3 and C-14, with other nuclides such as Co-60 and Cs-137 in trace amounts. In a heavy water reactor, the high content of O-17 in heavy water reacts with neutrons to release an alpha particle, which turns into C-14. As a result, the spent resin in the heavy water reactor has captured C-14, which emits becquerels as high as 10^{6˜7} bq/g.

Since C-14 is captured at high purity in the spent resin of the heavy water reactor, it is possible to use the C-14 nuclide when only C-14 is selectively separated through proper processing. Currently, the supply of C-14 is monopolized by Russia, and although China has recently begun producing C-14 to meet its own demand, there is still a supply shortage. Recently, the price of C-14 nuclide has increased by five times or more, and the demand for C-14 as a labeling compound is expected to gradually increase due to the development of the pharmaceutical business. When radioactive waste that is difficult to dispose of can be recycled into high-value added materials that can be used in the pharmaceutical business, it is expected to generate huge economic benefits.

As an existing desorption technology, a method has been developed that uses acids to selectively desorb only C-14 (Patent document 001). The patent above has an advantage in that only C-14 can be selectively desorbed without destroying functional groups by processing acids, but it has a disadvantage in that a large amount of acidic liquid waste is generated, and in particular, the acidic liquid waste includes nuclides such as Co-60 and Cs-137 that have been adsorbed on the spent resin. Therefore, there is a need for a technology that can selectively desorb only C-14 from the functional groups while other nuclides are not desorbed.

Patent document 002 discloses a technology that uses microwaves to remove a C-14 nuclide from the spent resin while generating relatively little secondary waste. However, it is difficult to efficiently control the process of stably desorbing C-14 in the form of H¹⁴CO³⁻ without destroying the ammonium functional group, and it has a disadvantage in that the ammonium functional group is destroyed and released as water is removed. In addition, there is a disadvantage in that in the existing microwave treatment process, tritium is not completely removed from a condenser, and the C-14 is captured in the form of CaCO₃, the tritium is present in the crystalline water, which is not suitable for recycling.

### DOCUMENTS OF RELATED ART

(Patent Document 001) KR 10-0739855 B1
(Patent Document 002) KR 10-1907922 B1

### SUMMARY OF THE INVENTION

The present invention has been made in an effort to solve the above-mentioned disadvantages, and an object of the present invention is to provide a method and apparatus for irradiating a spent resin raw material with a microwave in the presence of moisture, removing water vapor including ³T₂O, without generating a large amount of secondary waste, and selectively desorbing and recycling C-14 in a spent resin.

The present invention provides a method of recycling C-14 in a spent resin, the method includes: i) heating a spent resin raw material including ¹⁴CO₂ in the presence of moisture by microwave irradiation; ii) refluxing, by condensation, water vapor in a first processing gas produced by the microwave irradiation and released from the spent resin raw material; and iii) removing water vapor from the first processing gas by the refluxing, and transporting a second processing gas including ¹⁴CO₂, which is released from the spent resin raw material, to the outside.

Further, the present invention provides an apparatus for recycling C-14 in a spent resin, the apparatus includes: a microwave irradiation unit 100 configured to irradiate and heat a spent resin raw material including ¹⁴CO₂ in the presence of moisture with a microwave; a reflux unit 110 configured to reflux water vapor of a first processing gas produced in the microwave irradiation unit 100 and released from the spent resin raw material by condensation; and a transportation unit 120 configured to transport a second processing gas including ¹⁴CO₂, which is removed by refluxing water vapor from the first processing gas, released from the spent resin raw material, to the outside.

When a method of recycling a C-14 nuclide in a spent resin according to the present invention is used, the C-14 nuclide can be selectively desorbed, which has an effect of increasing the recycling of the C-14 nuclide. In addition, when a method of recycling a C-14 nuclide in a spent resin according to the present invention is used, a large amount of acid is not used to desorb the C-14 nuclide, thereby reducing the amount of secondary waste.

### BRIEF DESCRIPTION OF THE DRAWINGS

FIG. 1 is an experimental apparatus used in Examples 1 to 6 and Comparative Example 1.

FIG. 2 is a schematic view of a C-14 recycling desorption process of the present invention.

FIG. 3 is a schematic view of a C-14 recycling adsorption process of the present invention.

### DETAILED DESCRIPTION OF THE INVENTION

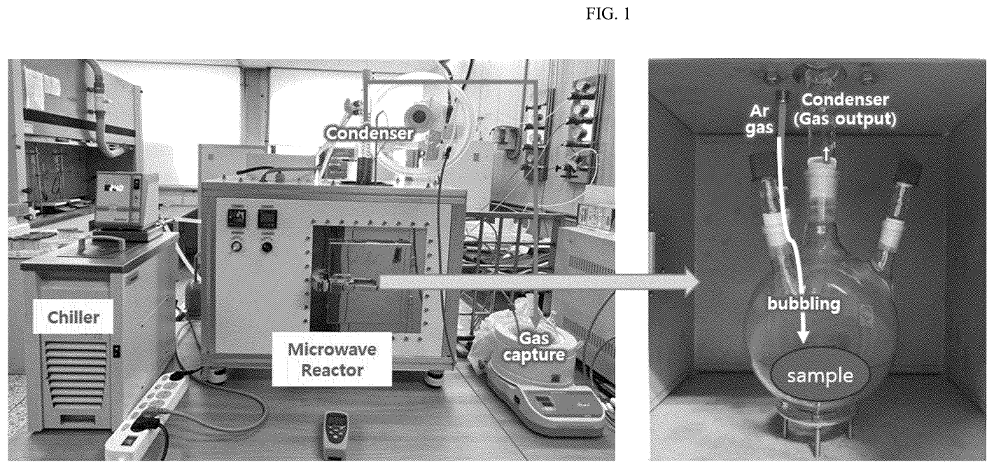

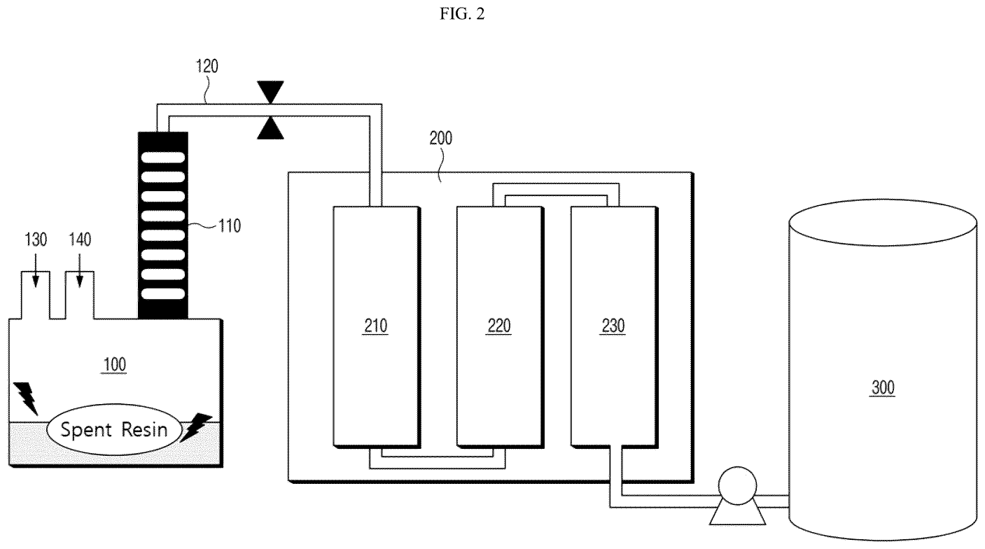

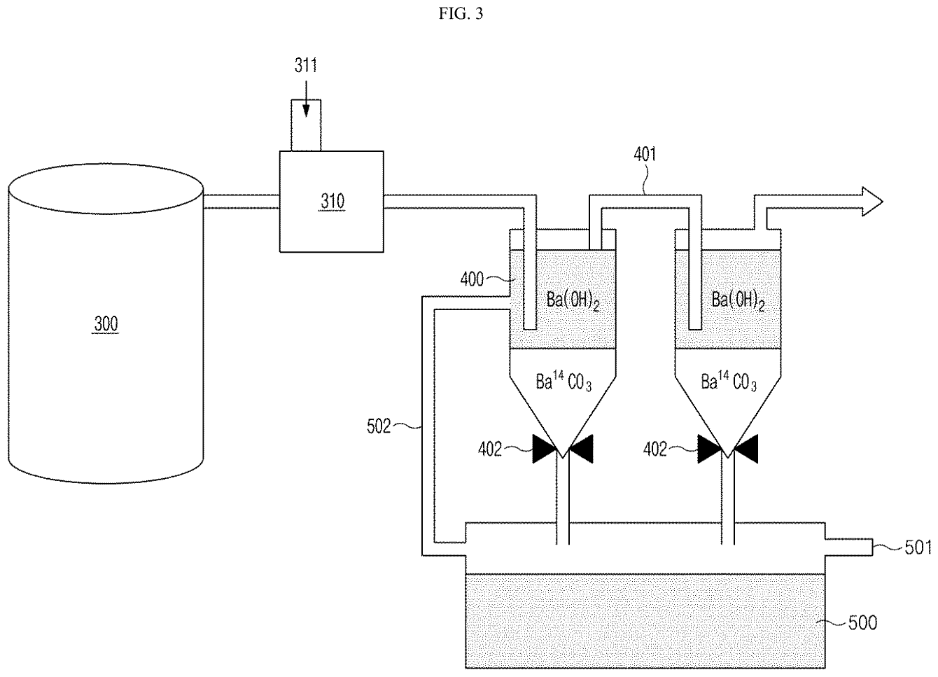

The present invention provides a method of recycling C-14 in a spent resin. Hereinafter, a method of recycling C-14 in a spent resin according to the present invention will be described in detail with reference to FIGS. 1 to 3.

In an embodiment of the present invention, a method of recycling C-14 in a spent resin may include: i) heating a spent resin raw material including ¹⁴CO₂ in the presence of moisture by microwave irradiation; ii) refluxing, by condensation, water vapor in a first processing gas produced by the microwave irradiation and released from the spent resin raw material; and iii) removing water vapor from the first processing gas by the refluxing, and transporting a second processing gas including ¹⁴CO₂, which is released from the spent resin raw material, to the outside.

In addition, in an embodiment of the present invention, an apparatus for recycling C-14 in a spent resin may include: a microwave irradiation unit 100 configured to irradiate and heat a spent resin raw material including ¹⁴CO₂ in the presence of moisture with a microwave; a reflux unit 110 configured to reflux water vapor of a first processing gas produced in the microwave irradiation unit 100 and released from the spent resin raw material by condensation; and a transportation unit 120 configured to transport a second processing gas including ¹⁴CO₂, which is removed by refluxing water vapor from the first processing gas, released from the spent resin raw material, to the outside.

In an embodiment of the present invention, the microwave irradiation unit 100 of the present invention generates a microwave. Korean Patent No. 10-1545440 discloses a method of generating ¹⁴CO₂, which is a radionuclide, by heating a waste air purification agent (activated carbon or zeolite) by a microwave in a reactor for a certain period of time, and this method may also be applied the case of generating ¹⁴CO₂ by heating the spent resin of the present invention.

The microwaves generated within the microwave irradiation unit 100 may heat and dry the spent resin, and the first processing gas including ¹⁴CO₂ may be separated from the spent resin. Here, a frequency of the microwave may be, for example, 2.45 GHz, but is not limited thereto. The first processing gas including ¹⁴CO₂ may include water vapor (H₂O and ³T₂O) or other gases other than ¹⁴CO₂. The C-14, which is a radioactive carbon, is included in the ¹⁴CO₂ of a gas including ¹⁴CO₂.

The water vapor of the first processing gas released from the spent resin raw material may pass through the reflux unit 110. A cooler 111 (not illustrated) having a cooling temperature of 10° C., 5° C., or 0° C. may remove heat in the reflux unit 110. The water vapor is condensed by the cooler and transported within the microwave irradiation unit 100, and some of the water vapor may still be present in the form of water vapor.

The first processing gas passes through the reflux unit 110 and some of the water vapor is removed, which becomes the second processing gas including ¹⁴CO₂ released from the spent resin raw material side. The second processing gas including ¹⁴CO₂ may be transported to a tritium removal unit 200 by the transportation unit 120, which transports the second processing gas externally.

In an embodiment of the present invention, the moisture in step i) above of the method of recycling C-14 in the spent resin may include moisture contained in the spent resin raw material and moisture derived from water input from the outside through an inlet 130.

In an embodiment of the invention, the amount of moisture in step i) above of the method of recycling C-14 in the spent resin of the present invention may be 80 to 250 parts by weight, 100 to 220 parts by weight, or 130 to 200 parts by weight, relative to 100 parts by dry weight of the spent resin raw material. The content of the moisture in the spent resin may include both moisture in the spent resin itself and moisture derived from water input from the outside. As the moisture content in the spent resin satisfies the range described above, the spent resin raw material does not increase to a high temperature due to water introduced by the reflux, despite being heated by the microwave, and a substantial amount of ¹⁴CO₂ may be desorbed without desorbing ammonium groups.

The spent resin may be in a saturated moisture state when the spent resin contains 100 parts by weight of moisture relative to 100 parts by weight of dry weight of the spent resin raw material at room temperature. The spent resin may be in a supersaturated moisture state when the spent resin contains moisture of more than 100 parts by weight relative to 100 parts by dry weight.

In an embodiment of the present invention, except for the moisture contained in the spent resin raw material, the water input from the outside may be 20 to 160 parts by weight, 40 to 140 parts by weight, or 60 to 100 parts by weight, relative to 100 parts by dry weight of the spent resin raw material assumed to be the spent resin raw material in a saturated moisture state at room temperature. When the amount of water input from the outside exceeds an upper limit of the range above, the spent resin may not be heated sufficiently to desorb ¹⁴CO₂, and when the amount of water input from the outside is below a lower limit of the range above, the resin may be overheated and ammonium groups may be desorbed.

In an embodiment of the present invention, in the microwave irradiation of the method of recycling C-14 in the spent resin of the present invention, an output power of the microwave may be controlled variably, and the microwave irradiation may be performed for 30 to 120 minutes, 40 to 110 minutes, or 50 to 100 minutes such that the spent resin raw material is at a temperature of 60 to 95° C., or 65 to 90° C., or 70 to 100° C. As the microwave irradiation is performed to satisfy within the range described above, ¹⁴CO₂ can be selectively desorbed without desorbing the ammonium groups.

In an embodiment of the present invention, the spent resin raw material may include a spent ion exchange resin from a heavy water nuclear power plant. The radioactive spent resin may be a radioactive spent resin derived from a heavy water reactor. The radioactive spent resin may include various radionuclides, such as C-14, Co-60, and Cs-137, and may also be stored with a storage solution including C-14, tritium, and the like. Specifically, the ion exchange resin may include at least one resin selected from the group consisting of IRN-77, IRN-78, and IRN-150. For example, the IRN-150 ion exchange resin is composed of a polystyrene-divinylbenzene copolymer and may include a sulfuric acid functional group for a cation exchange resin and a tetravalent ammonium functional group for an anion exchange resin.

In an embodiment of the present invention, the tetravalent ammonium functional group may be of a form in which only the methyl group bonded to the ammonium group is removed, in case that the spent resin raw material in which sufficient moisture is present is not excessively heated.

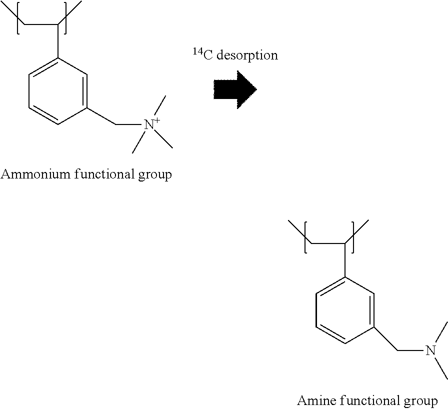

Meanwhile, in an embodiment of the present invention, in the tetravalent ammonium functional group, the ammonium group may be desorbed in the form of including methylamine in case that sufficient moisture is not present.

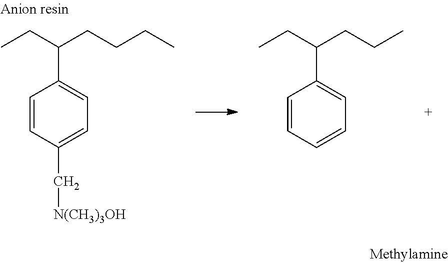

In an embodiment of the present invention, the method of recycling C-14 in the spent resin may further include purging a dissolved gas in water by introduction of a carrier gas through a carrier gas injection port 140, prior to step i) above. The carrier gas may include, for example, any one of nitrogen, helium, argon, and synthetic air. The purging step may be performed, for example, by opening a vent 101 (not illustrated) and introducing the carrier gas into the water, removing CO₂ dissolved in the moisture and internal existing gases, and then closing the vent.

In an embodiment of the present invention, the method of recycling C-14 in the spent resin of the present invention may further include obtaining a final processing gas including ¹⁴CO₂ by removing water vapor including ³T₂O residual in the second processing gas in the tritium removal unit 200.

Specifically, the water vapor including ³T₂O may be removed by at least one of condensation, absorption, and adsorption in a tritium condensation unit 210, a tritium absorption unit 220, and a tritium adsorption unit 230 to obtain the final processing gas. For example, the condensation unit 210 may include a condensation pipe 211, which may be connected to refrigerant circulation pipes 212 and 213 to circulate refrigerant that is cooled by a cooling device 214. The moisture contained in the second processing gas from the reactor may be condensed while passing through the condenser 210 and transported to the tritium absorption unit 220. The tritium absorption unit 220 may absorb the moisture in a desiccant method. Specifically, the tritium absorption unit may adsorb the moisture using a drying agent including silica to remove tritium. The tritium adsorption unit 230 may remove tritium by a moisture removal trap including a zeolite.

In an embodiment of the present invention, the method of recycling C-14 in the spent resin of the present invention may further include compressing and storing the final processing gas in a storage unit 300. The storage unit 300 may exist at a high pressure through a pressure pump.

In an embodiment of the present invention, the storage unit 300 may further include a flow rate control device 310. In addition, the flow rate control device 310 may further include a carrier gas injection port 311. The carrier gas may include, for example, any one of nitrogen, helium, argon, and synthetic air. The ¹⁴CO₂ stored in the storage unit 300 can be mixed with a carrier gas introduced through the carrier gas injection port 311 and transported to a ¹⁴CO₂ adsorption unit 400. In this case, the ¹⁴CO₂ may be transported by the flow rate control device 310 to the ¹⁴CO₂ adsorption unit 400 at a suitable flow rate in consideration of the adsorption efficiency.

In an embodiment of the present invention, the method of recycling C-14 in the spent resin of the present invention may further include producing Ba¹⁴CO₃ by subjecting ¹⁴CO₂ in the final processing gas to be in contact with a CO₂ absorbent including Ba(OH)₂ in the ¹⁴CO₂ adsorption unit 400. One or more plurality of ¹⁴CO₂ adsorption units 400 of the present invention, that is, two to six ¹⁴CO₂ adsorption units may be disposed in series or in parallel, and each of the adsorption units may be connected to a ¹⁴CO₂ capture pipe 401.

Here, the absorbent may include Ba(OH)₂. The Ba(OH)₂ may react with ¹⁴CO₂ to produce Ba¹⁴CO₃, removing C-14, which is a radioactive carbon. The produced Ba¹⁴CO₃ may be recycled for a separate purpose. The produced Ba¹⁴CO₃ may be present at a lower end of the ¹⁴CO₂ adsorption unit 400 in the form of a precipitate, and may be transported to a CO₂ absorbent recycling unit 500 by a stopper 402 of the CO₂ adsorption unit. In this case, the input carrier gas is discharged as an exhaust gas.

In an embodiment of the present invention, the method of recycling C-14 in the spent resin may further include removing the produced Ba¹⁴CO₃ from the CO₂ absorbent recycling unit 500 and reusing an unreacted CO₂ absorbent to be in contact with ¹⁴CO₂. A cleaning solution including deionized water (DI water) may be input to the CO₂ absorbent recycling unit 500 through a cleaning solution inlet pipe 501 to dissolve and remove the CO₂ absorbent including Ba(OH)₂ present on a surface of the Ba¹⁴CO₃. The cleaning solution in which the Ba(OH)₂ is dissolved can be reused in the ¹⁴CO₂ adsorption unit 400 by inputting additional Ba(OH)₂.

### EXAMPLES

Hereinafter, the present invention will be described in more detail with reference to examples. However, these examples are just for illustrative purposes and not intended to limit the scope of the present invention in any way.

### Example 1

a) Simulated spent resin was prepared by adsorbing HCO₃⁻ ions onto IRN-150 resin used in actual nuclear power plants at a ratio of 1 mg of CO₂ per 1 g of resin. After 100 g of the spent resin raw material (50 g of dry weight of the spent resin raw material and 50 g of moisture contained in the vPtnwl raw material) was input into the radioactive microwave irradiation unit 100, an additional 25 g of water (50 parts by weight compared to 100 parts by dry weight of the spent resin raw material) was input into the spent resin raw material through the inlet 130. Then, Ar(g) was injected into the water through the carrier gas injection port 140 to purge dissolved gases in the water. Then, the microwave was irradiated for 60 minutes, and the first processing gas released from the spent resin raw material passed through the reflux unit 110 with a temperature of 5° C. to be cooled down to condense the water vapor in the first processing gas, and the second processing gas including ¹⁴CO₂ was transported to the tritium removal unit 200 through the transportation unit 120. In this case, the output power of the microwave was adjusted to maintain the temperature of the spent resin at 100° C. or less.

b) The second processing gas produced by the microwave irradiation in step a) above was input to the tritium removal unit 200, passed through the tritium condensation unit 210, the tritium absorption unit 220, and the tritium adsorption unit 230, and the water vapor including tritium in the second processing gas was removed, and the final processing gas including ¹⁴CO₂ was stored in the storage unit 300.

c) The final processing gas produced through step b) above and stored in the storage unit 300 was input to the ¹⁴CO₂ adsorption unit 400 containing the CO₂ absorbent (Ba(OH)₂) at a constant rate controlled by the flow rate control device to be absorbed on the CO₂ absorbent (Ba(OH)₂). The solid Ba¹⁴CO₃(s) produced through the reaction of ¹⁴CO₂ and Ba(OH)₂ moved to the CO₂ absorbent recycling unit 500, and the solid Ba¹⁴CO₃(s) was removed, and the unreacted CO₂ absorbent (Ba(OH)₂) moved to the ¹⁴CO₂ adsorption unit 400 through the recycling unit 502, and the CO₂ absorbent (Ba(OH)₂) was recycled.

### Example 2

Example 2 was performed in the same method as Example 1 above, except that no additional water was input to the spent resin raw material.

### Example 3

Example 3 was performed in the same method as Example 1 above, except that additional 50 g of water (100 parts by weight compared to 100 parts by dry weight of the spent resin raw material) was input to the spent resin raw material.

### Example 4

Example 4 was performed in the same method as Example 1 above, except that the microwave was irradiated for 40 minutes.

### Example 5

Example 5 was performed in the same method as Example 1, except that microwave irradiation was performed for 40 minutes in Example 2.

### Example 6

Example 6 was performed in the same method as Example 1, except that microwave irradiation was performed for 40 minutes in Example 3.

### Comparative Example 1

Comparative Example 1 was performed in the same method as Example 1 above, except that in Example 2 above, the transportation to the tritium removal unit 200 was performed without passing through the reflux unit 110.

### Experimental Example

The spent resins of Examples 1 to 4 and Comparative Examples 1 to 2, after undergoing steps a) to c) above, exhibit the same morphology as before step a). Therefore, it was confirmed that only C-14 can be selectively desorbed while maintaining moisture in the spent resin processing.

Confirmation of Desorption Rate

The ¹⁴CO₂ desorption rate of the spent resin of Examples 1 to 6, Comparative Example 1 and IRN-150 was measured through gas chromatography. Specifically, to analyze the ¹⁴CO₂ remaining in the spent resin after the desorption reaction, the spent resin of Examples 1 to 6 and Comparative Example 1 was treated with acid to desorb the ¹⁴CO₂, which was then analyzed by gas chromatography, as shown in Table 1 below. In this case, the desorption rate is the desorbed ¹⁴CO₂ relative to the adsorbed ¹⁴CO₂.

TABLE 1

| | Desorption rate (%) |
|---|---|
| Example 1 | 59.90 |
| Example 2 | 41.06 |
| Example 3 | 25.43 |
| Example 4 | 18.34 |
| Example 5 | 22.80 |
| Example 6 | 7.82 |
| Comparative Example 1 | 99% |

Confirmation of Whether Ammonium Group is Desorpted

The C/N ratios of Examples 1 to 3, Comparative Example 1, and IRN-150 were derived using an elemental analyzer (FLASH2000 Thermo Scientific) and are shown in Table 2 below.

TABLE 2

| | C/N ratio |
|---|---|
| Example 1 | 40.5 |
| Example 2 | 58.4 |
| Example 3 | 39.1 |
| Comparative Example 1 | 67.2 |
| IRN-150 | 37.8 |

As can be seen in Table 1 above, the ¹⁴CO₂ was successfully desorbed from Examples 1 to 6 and Comparative Example 1. Meanwhile, as can be seen in Table 2 above, it was confirmed that the C/N ratio is high when the reflux unit is not used, which means that the content of N is relatively low. Therefore, it was confirmed that the ammonium group in the spent resin is desorbed relatively more when the reflux unit is not used.

Meanwhile, in case of Example 2, where no additional water was input to the spent resin raw material, it was confirmed that the ammonium was desorbed relatively less by using the reflux unit.

In cases of Examples 1 and 3, where water was additionally input to the spent resin raw material, it was confirmed that the ammonium functional group was relatively little desorbed.

### DESCRIPTION OF REFERENCE NUMERALS

1: Spent resin raw material
100: Microwave irradiation unit
101: Vent
110: Reflux unit
111: Cooler
120: Transportation unit
130: Inlet
140: Carrier gas injection port
200: Tritium removal unit
210: Tritium condensation unit
211: Condensation pipe
212 and 213: Refrigerant circulation pipe
214: Cooling device
220: Tritium absorption unit
230: Tritium adsorption unit
300: Storage unit
310: Flow rate control device
311: Carrier gas injection port
400: ¹⁴CO₂ adsorption unit
401: ¹⁴CO₂ capture pipe
402: Stopper
500: CO₂ absorbent recycling unit
501: Cleaning solution inlet pipe
502: Recycling unit

What is claimed is:

1. A method of recycling C-14 in a spent resin, the method comprising:
i) heating a spent resin raw material including ¹⁴CO₂ in the presence of moisture by microwave irradiation;
ii) refluxing, by condensation, water vapor in a first processing gas produced by the microwave irradiation and released from the spent resin raw material; and
iii) removing water vapor from the first processing gas by the refluxing, and transporting a second processing gas including ¹⁴CO₂, which is released from the spent resin raw material, to the outside.

2. The method of claim 1, wherein the moisture in step i) comprises moisture contained in the spent resin raw material and moisture derived from water input from the outside.

3. The method of claim 1, wherein the amount of moisture in step i) is 80 to 250 parts by weight per 100 parts by dry weight of the spent resin raw material.

4. The method of claim 1, wherein the spent resin raw material is heated by microwave irradiation for 30 to 120 minutes to a temperature of 70 to 100° C.

5. The method of claim 1, wherein the spent resin raw material comprises a spent ion exchange resin from a heavy water nuclear power plant.

6. The method of claim 5, wherein the ion exchange resin comprises at least one resin selected from the group consisting of IRN-77, IRN-78, and IRN-150.

7. The method of claim 1, further comprising:
purging dissolved gases in water by a carrier gas being input, prior to step i) above.

8. The method of claim 1, further comprising:
obtaining a final processing gas including ¹⁴CO₂ by removing water vapor including ³T₂O residual in the second processing gas.

9. The method of claim 8, wherein the water vapor including the ³T₂O is removed by at least one of condensation, absorption, and adsorption so that a final processing gas is obtained.

10. The method of claim 8, further comprising:
compressing and storing the final processing gas.

11. The method of claim 8, further comprising:
producing Ba¹⁴CO₃ by contacting ¹⁴CO₂ in the final processing gas with a CO₂ absorbent including Ba(OH)₂.

12. The method of claim 11, further comprising:
removing the produced Ba¹⁴CO₃, and reusing an unreacted CO₂ absorbent (Ba(OH)₂) to be in contact with ¹⁴CO₂.

13. An apparatus for recycling C-14 in a spent resin, the apparatus comprising:
a microwave irradiation unit 100 configured to irradiate and heat a spent resin raw material including ¹⁴CO₂ in the presence of moisture with a microwave;
a reflux unit 110 configured to reflux water vapor of a first processing gas produced in the microwave irradiation unit 100 and released from the spent resin raw material by condensation; and
a transportation unit 120 configured to transport a second processing gas including ¹⁴CO₂, which is removed by refluxing water vapor from the first processing gas, released from the spent resin raw material, to the outside.

14. The apparatus of claim 13, wherein the microwave irradiation unit 100 further comprises an inlet 130 configured to introduce water into the spent resin raw material from the outside.

15. The apparatus of claim 13, wherein the microwave irradiation unit 100 further comprises a carrier gas injection port 140 configured to purge dissolved gases in water.

16. The apparatus of claim 13, further comprising:
a tritium removal unit 200 configured to obtain a final processing gas including ¹⁴CO₂ by removing water vapor including ³T₂O residual in the second processing gas.

17. The apparatus of claim 16, wherein the tritium removal unit 200 comprises a tritium condensation unit 210, a tritium absorption unit 220, and a tritium adsorption unit 230.

18. The apparatus of claim 16, further comprising:
a storage unit 300 configured to compress and store the final processing gas.

19. The apparatus of claim 16, further comprising:
a ¹⁴CO₂ adsorption unit 400 configured to produce Ba¹⁴CO₃ by contacting ¹⁴CO₂ in the final processing gas with a CO₂ absorbent (Ba(CO)₂).

20. The apparatus of claim 19, further comprising:
a CO₂ absorbent recycling unit 500 configured to remove the produced Ba¹⁴CO₃, and reuse an unreacted CO₂ absorbent (Ba(OH)₂) to be in contact with ¹⁴CO₂.
